(19) United States
(12) Patent Application Publication
(10) Pub. No.: US 2019/0178072 A1
(43) Pub. Date: Jun. 13, 2019

(54) BRAKE ASSEMBLY FOR A TUBULAR CONNECTION SYSTEM

(71) Applicant: Tesco Corporation, Houston, TX (US)

(72) Inventors: Ryan Thomas Bowley, Calgary (CA); Brent James-William Coombe, Calgary (CA)

(21) Appl. No.: 15/834,561

(22) Filed: Dec. 7, 2017

(51) Int. Cl. E21B 44/00; F16D 55/22; E21B 3/02

(52) U.S. Cl. CPC E21B 44/00; F16D 2127/005; E21B 3/02; F16D 55/22

(57) ABSTRACT

Embodiments of the present disclosure are directed to a drilling system that includes a top drive of a drilling rig configured to transfer a torque to a tubular element, a torque sensing component configured to measure the torque applied to the tubular, a brake assembly coupled to the tubular element, where the brake assembly is configured to block torque transfer from the top drive to the tubular element at a predetermined torque value, and a controller communicatively coupled to the torque sensing component and the brake assembly, where the controller is configured to receive feedback from the torque sensing component and send a signal to actuate the brake assembly based on the torque measured by the torque sensing component.

### BACKGROUND

Embodiments of the present disclosure relate generally to the field of drilling and processing of wells. More particularly, present embodiments relate to a system and method for a brake system that facilitates establishing tubular connections on a drilling rig.

In existing oil and gas operations, a well is typically drilled to a desired depth with a drill string, which includes drill pipe and a drilling bottom hole assembly. Once the desired depth is reached, the drill string is removed from the hole and casing is run into the vacant hole. Casing may be defined as pipe or tubular that is placed in a well to prevent the well from caving in, to contain fluids, and/or to assist with efficient extraction of product (e.g., oil). Tubular may be defined as including drill pipe, casing, or any other type of substantially cylindrical component or assembly utilized in drilling or well processing operations.

A tubular is generally lowered into the wellbore by a top drive, which typically includes a quill. The quill is a short length of pipe that couples with the upper end of the tubular and one or more motors configured to turn the quill. The top drive is typically suspended from a traveling block above the rig floor so that it may be raised and lowered throughout drilling operations. To establish connections between a new length of tubular and an existing string of tubular, the new length of tubular is lowered onto the existing string via the top drive, and the top drive applies a torque to thread the new length of tubular onto the existing string. Unfortunately, traditional operations used to monitor and control the amount of torque applied while making these connections have certain drawbacks. For example, existing systems allow for the top drive to apply too much torque or not enough torque while forming tubular connections.

### BRIEF DESCRIPTION

In accordance with one aspect of the disclosure a drilling system includes a top drive of a drilling rig configured to transfer a torque to a tubular element, a torque sensing component configured to measure the torque applied to the tubular, a brake assembly coupled to the tubular element, where the brake assembly is configured to block torque transfer from the top drive to the tubular element at a predetermined torque value, and a controller communicatively coupled to the torque sensing component and the brake assembly, where the controller is configured to receive feedback from the torque sensing component and send a signal to actuate the brake assembly based on the torque measured by the torque sensing component.

In accordance with another aspect of the disclosure, a drilling system includes a torque sensing component configured to measure a torque applied from a top drive to a tubular, a brake assembly configured to couple to the tubular element, where the brake assembly is configured to block torque transfer from the top drive to the tubular element at a predetermined torque value, and a controller communicatively coupled to the torque sensing component and the brake assembly, where the controller is configured to receive feedback from the torque sensing component and send a signal to actuate the brake assembly based on the torque measured by the torque sensing component.

In accordance with another aspect of the disclosure, a method includes receiving feedback indicative of a measured torque value applied to a tubular element by a top drive from a torque sensing device, sending a first signal to an actuator of a brake assembly based on the measured torque value applied to the tubular element by the top drive, and actuating the brake assembly to block torque transfer from the top drive to the tubular element, such that a torque applied at a connection between the tubular element and a tubular string is substantially equal to the predetermined torque value.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of an embodiment of a well being drilled, in accordance with an aspect of the present disclosure;

FIG. 2 is a schematic of an embodiment of a brake assembly for a tubular connection system, in accordance with an aspect of the present disclosure;

FIG. 3 is a perspective view of an embodiment of the brake assembly of FIG. 2, in accordance with an aspect of the present disclosure;

FIG. 4 is a perspective view of an embodiment of the brake assembly of FIG. 2, in accordance with an aspect of the present disclosure; and

FIG. 5 is a block diagram of an embodiment of a process for connecting tubulars with the brake assembly of FIGS. 2-4, in accordance with an aspect of the present disclosure.

### DETAILED DESCRIPTION

Present embodiments are directed toward a brake assembly for a tubular connection system, which facilitates formation of connections between tubulars to form a tubular string in drilling operations. More specifically, present embodiments are directed to a brake assembly having discs or drums that are configured to stop rotation of a top drive and one or more tubulars at a predetermined torque (e.g., a target torque). Existing systems may utilize a clutch, which enables selective frictional engagement of two portions of a sub. For example, the clutch enables torque transfer from a rotating top drive to a tubular element when activated and isolates the tubular element from the rotating top drive when released. Unfortunately, clutches of existing systems disengage the top drive from the tubular element when released, thereby limiting a torque applied to the tubular element to a torque that was transferred right before release of the clutch. In other words, the torque applied to the tubular element may not be adjusted upon release of the clutch. Additionally, the clutch is relatively complex and includes various rotating components, which may undergo routine maintenance to ensure adequate operation. It is now recognized that an improved brake assembly included in a drilling rig will maintain a connection between the top drive and the tubular element, while also sustaining a torque applied to the tubular element at a predetermined torque value (e.g., a target torque). Additionally, the brake assembly includes a reduced number of rotating components when compared to the clutch, thereby reducing maintenance costs of the drilling rig.

As such, embodiments of the present disclosure relate to a brake assembly configured to block torque transfer from the top drive to a tubular element at the target torque. For example, the brake assembly may include a plurality of discs and/or drums that may block rotation of the tubular element to maintain a connection between the tubular element and another component (e.g., a drill string) at the target torque. Once the brake system is activated (e.g., the plurality of discs and/or drums is engaged), a motor of the top drive may be turned off and the brake system may be released to dissipate any excess torque, while maintaining a torque at the connection between the tubular element and the other component at the target torque. The top drive and/or a quill of the top drive may also be blocked from rotation when the brake assembly is activated, such that rotating components associated with the clutch in existing systems may be eliminated. Moreover, the tubular element remains coupled to and/or engaged with the top drive, such that the top drive may apply additional torque and/or reduce a torque applied to the tubular element after the brake system has been released.

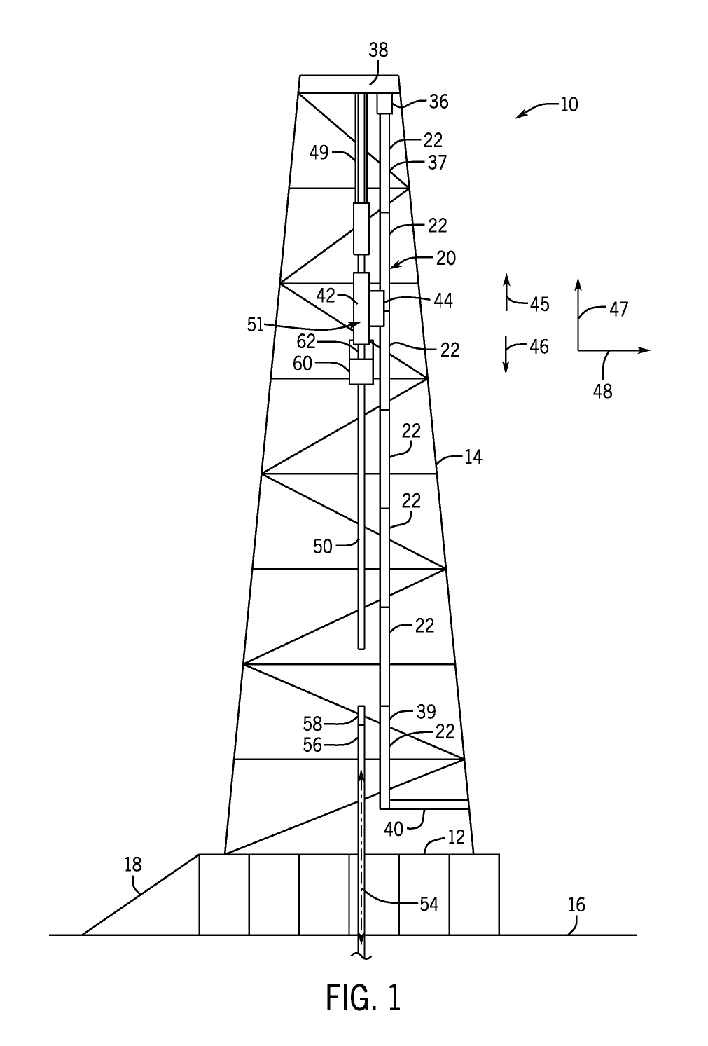

Turning now to the drawings, FIG. 1 is a schematic representation of a drilling rig 10 in the process of drilling a well in accordance with an embodiment of the present disclosure. The drilling rig 10 features an elevated rig floor 12 and a derrick 14 extending above the rig floor 12. The elevated rig floor 12 is positioned above ground 16. As illustrated, a pipe ramp 18 extends from the ground 16 to the elevated rig floor 12 and may be used to aid in moving pipe from the ground 16 to the rig floor 12. A torque track system 20 extends from a bottom portion of the derrick 14 to a top portion of the derrick 14. The torque track system 20 is used to transfer torsional loads from a drilling operation to the derrick 14. The torque track system 20 includes multiple elongate torque track segments 22. As will be appreciated, the torque track system 20 may include any number of elongate torque track segments 22, and such torque track segments 22 may vary in length in relation to each other. Further, it should be noted that the derrick 14 may vary in height resulting in torque track systems 20 that vary in length.

To attach the torque track system 20 to the derrick 14, an adjustable hanging cluster 36 is coupled to a first end elongate torque track segment 37. The hanging cluster 36 is attached to a crown beam 38 (e.g., using a pad eye welded to the crown beam 38). A second end elongate torque track segment 39 positioned at the bottom of the derrick 14 (e.g., a T-bar connector) is secured to the derrick 14 by fastening the torque track segment 39 to a T-bar 40. The T-bar 40 is fastened directly to the derrick 14 (e.g., such as by fastening the T-bar 40 to a torque anchor beam located at the bottom portion of the derrick 14). As will be appreciated, in other embodiments, the torque track system 20 may be coupled to the derrick 14 in other ways.

In some embodiments, a top drive 42 is coupled to the torque track system 20 by a carriage assembly 44, which may be considered a component of the top drive 42. The carriage assembly 44 guides the top drive 42 along the torque track system 20 as the top drive 42 moves in a first direction 45 and/or a second direction 46 along a vertical axis 47 between the bottom and the top of the derrick 14. As shown in the illustrated embodiment, the torque track system 20 generally extends along the vertical axis 47, such that the torque track system 20 may block (e.g., resist) lateral movement of the top drive 42 along a horizontal axis 48. Additionally, the torque track system 20 may transfer torsional loads incurred during drilling operations to the derrick 14, thereby reducing wear on the top drive 42. The top drive 42 may be suspended by a cable arrangement 49 which may be looped around the crown beam 38, or otherwise attached to the crown beam 38. Further, a tubular element 50 is coupled to the top drive 42. In some embodiments, the tubular element 50 is coupled to the top drive 42 via a grabber box 51. For example, the grabber box 51 may receive the tubular element 50 from a catwalk (not shown) and couple the top drive 42 to the tubular element 50, such that the top drive 42 may transfer torque to the tubular element 50. The top drive 42 is used to rotate, raise, and lower the tubular element 50, among other things.

In some embodiments, the top drive 42 hoists the tubular element 50 to a vertically aligned position over a center of the wellbore 52. That is, the tubular element 50 is aligned with a vertical axis 54 that passes through the center of the wellbore 52. Accordingly, the tubular element 50 is aligned with a tubular string 56 extending into the wellbore 52. From this position, the tubular element 50 can be lowered (e.g., stabbed) onto a stump 58 of the tubular string 56, rotated to form a connection between the tubular element 50 and the tubular string 56, and eventually lowered into the wellbore 52.

As shown in the illustrated embodiment of FIG. 1, the drilling rig 10 may be equipped with a brake assembly 60 coupled to the top drive 42. For example, the brake assembly 60 may be configured to be coupled to the grabber box 51 and used to maintain a desired torque at a connection between the tubular element 50 and the stump 58 of the tubular string 56. Accordingly, the brake assembly 60 may be disposed around the tubular element 50 and/or a quill 62 of the top drive 42. Therefore, the brake assembly 60 may block torque transfer from the top drive 42 to the quill 62 and/or the tubular element 50 to maintain a target torque between the tubular element 50 and the tubular string 56. Although the brake assembly 60 is described throughout as being coupled to the grabber box 51, it should be noted that the brake assembly 60 may be coupled to other tools or equipment being hoisted over the rig floor 12.

It should be noted that the illustration of FIG. 1 is intentionally simplified to focus on the brake assembly 60 described in detail below. Many other components and tools may be employed during the various periods of formation and preparation of the well. Similarly, as will be appreciated by those skilled in the art, the orientation and environment of the well may vary widely depending upon the location and situation of the formations of interest. For example, rather than a generally vertical bore, the well, in practice, may include one or more deviations, including angled and horizontal runs. Similarly, while shown as a surface (land-based) operation, the well may be formed in water of various depths, in which case the topside equipment may include an anchored or floating platform.

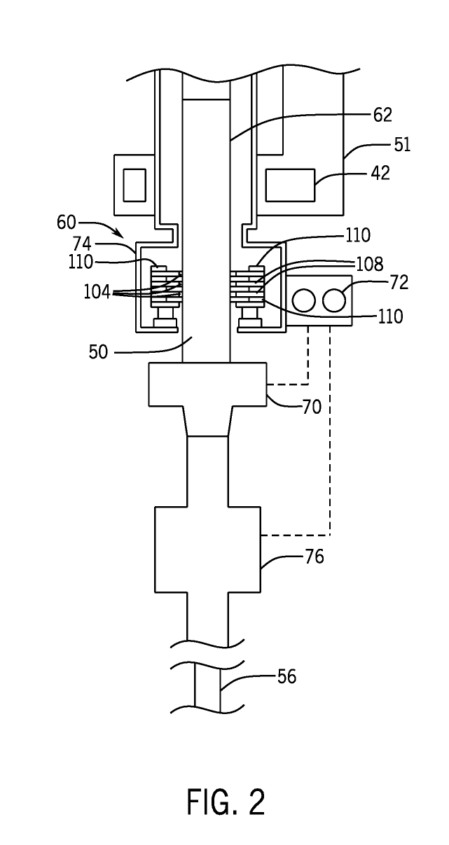

FIG. 2 is a schematic representation of an embodiment of the brake assembly 60 illustrated in FIG. 1. The brake assembly 60 is configured to surround a circumference of the tubular element 50 and/or the quill 62 of the top drive 42. As the top drive 42 rotates the quill 62, the tubular element 50 also rotates with the top drive 42 and the quill 62. As shown in the illustrated embodiment of FIG. 2, the drilling rig 10 includes a torque sensing device 70 (e.g., a wireless torque turn system (WTTS)) that may detect a measurement of the torque being transferred from the top drive 42 to the tubular element 50 (or tubular string). While the present discussion describes the torque sensing device 70 as a WTTS, any desirable torque sensing device 70 may be used to perform this measurement.

In some embodiments, the brake assembly 60 is used to block torque transfer from the top drive 42 to the tubular element 50 when feedback from the torque sensing device 70 indicates that a torque applied to the tubular element 50 reaches a predetermined torque value (e.g., a target torque). In other embodiments, the brake assembly 60 may gradually block torque transfer from the top drive 42 to the tubular element 50 when the feedback from the torque sensing device 70 indicates that the torque applied to the tubular element reaches a torque threshold, where the torque threshold is less than the predetermined torque value. As such, the brake assembly 60 is actuated at the torque threshold, but the torque transferred from the top drive 42 to the tubular element 50 continues to increase. Thus, the brake assembly 60 blocks the torque transfer between the top drive 42 and the tubular element 50 as the torque increases from the torque threshold to the predetermined torque value. Once the feedback from the torque sensing device 70 indicates that the torque is at the predetermined torque value, the brake assembly 60 may be fully actuated, such that the torque transfer between the top drive 42 and the tubular element 50 is substantially blocked at the predetermined torque value.

In some embodiments, the brake assembly 60 is communicatively coupled with the torque sensing device 70 (e.g., via a controller 72), so that the brake assembly 60 is activated when the torque applied to the quill 62 from the top drive 42 reaches the predetermined torque value or the torque threshold. That is, when the torque sensing device 70 determines that a measured torque on the quill 62 reaches the predetermined torque value or the torque threshold, the brake assembly 60 is activated to block torque transfer, or partially block torque transfer, from the top drive 42 to the tubular element 50. In some embodiments, the brake assembly 60 may include a plurality of calipers configured to stop or block rotation of a disc (e.g., brake disc) that rotates with the quill 62 of the top drive 42. Additionally or alternatively, the brake assembly 60 includes a brake drum system that includes a drum (e.g., a brake drum) that is configured to rotate with the quill 62 of the top drive 42. The brake drum system may include a plurality of brake shoes configured to stop or block rotation of the drum, and thus, the quill 62 of the top drive 42.

In any case, the brake assembly 60 enables the top drive 42 to transmit torque to the tubular element 50 while making connections between the tubular element 50 and the tubular string 56, as well as to suspend this torque transfer when the connection reaches a desired torque set point (e.g., the predetermined torque value or the torque threshold). The desired torque set point may be programmed into the controller 72 so that when the torque sensing device 70 detects the torque set point, a signal is sent to an actuator of the brake assembly 60 that instantaneously, nearly instantaneously, or gradually activates the brake assembly 60 to ultimately block a transfer of torque from the top drive 42 to the tubular element 50 at the predetermined torque value. As such, the brake assembly 60 controls the top drive 42 to avoid overtorquing (applying too much torque) or undertorquing (applying too little torque) the tubular element 50 while making the connection to the tubular string 56. Thus, the brake assembly 60 enables more accurate application of torque to the tubular element 50 than would be available through a driller watching and reacting to a torque readout at the driller's panel.

It should be noted that some embodiments of the present disclosure may not include the torque sensing device 70 illustrated in FIG. 2, but may instead include a mechanical actuator for selectively activating the brake assembly 60. For example, the mechanical actuator may include a pre-loaded spring that will begin to move, releasing a hair trigger for actuating the brake assembly 60 when the desired torque value (e.g., the predetermined torque value or the torque threshold) is reached. The mechanical actuator may be calibrated to activate the brake assembly 60 at the desired torque level. In other embodiments, the mechanical actuator may be used in conjunction with the described torque sensing device 70. This may be used to aid in the calibration of the mechanical actuator, or to provide live torque feedback to operators via the torque sensing device 70 while activating the brake assembly 60 via the mechanical assembly. It should be noted that other types of actuators may be employed in other embodiments, such as hydraulic actuators, pneumatic actuators, and so forth.

It should be noted that any number of possible brake designs may be used to form the brake assembly 60 in the disclosed embodiments. For example, as described in detail below, the brake assembly 60 may include disc brakes and calipers, drum brakes, or a combination of both. In other embodiments, the brake assembly 60 may include another suitable brake design that blocks torque transfer from the top drive 42 to the tubular element 50 at the target torque. The brake assembly 60 may be pneumatically actuated, hydraulically actuated, mechanically actuated (e.g., spring applied brakes), or electronically actuated.

The brake assembly 60 may enable the top drive 42 to make tubular connections more efficiently than would be possible using existing systems. For example, some systems may involve the use of a driller manually watching the torque value being applied by the top drive 42, or the top drive 42 may be equipped with a component that releases a pressure on the top drive 42 when a desired torque is reached. Additionally, existing systems include power tongs that are positioned over the tubular element 50 and the stump to complete the fully torqued connection when a certain torque is reached. Thus, the top drive 42 and a separate pair of power tongs are generally used to make connections. Switching between these components takes a considerable amount of time and effort. Additionally, other existing systems may include a clutch that isolates the top drive 42 from the tubular element 50 when a certain torque is reached. In other words, the clutch essentially disconnects the tubular element 50 from the top drive 42, such that the tubular element 50 is blocked from rotation, while the top drive 42 continues to rotate. The clutch may involve rotating components, which may undergo routine maintenance, thereby making operation of the drilling rig more complex and/or expensive. However, the presently disclosed brake assembly 60 is a system that enables the tubular element 50 to be connected to the tubular string 56 at a predetermined amount of torque. Moreover, the disclosed brake assembly 60 is able to complete connections without the use of power tongs and/or additional rotating components, thereby increasing the efficiency of the connection process as compared to existing systems.

As discussed above, the controller 72 may control the brake assembly 60 based upon the sensed torque detected by the torque sensing device 70. To that end, the controller 72 may receive signals from the torque sensing device 70 and output control signals to the brake assembly 60 in response to the measured torque values. Thus, the brake assembly 60 operates based on live feedback controls. As such, the torque sensing device 70 may be used by the controller 72 to actively control the brake assembly 60 to enable more accurate and repeatable operation, when compared to a drilling operator controlling the torque based on a readout or completing a connection using power tongs. Control between the controller 72 and the brake assembly 60 may be hydraulic fluid signals that actuate pistons that control movement of calipers, brake shoes, or other suitable brake components. In some embodiments, the controller 72 may include or may be located at a driller's panel or similar operator interface at the rig floor 12. This may enable the controller 72 to output a user viewable display of the measured torque from the torque sensing device 70 on a user interface and to provide control signals to the brake assembly 60. Additionally or alternatively, the controller 72 may provide alerts, visual displays, and override control functionality to operators at the rig floor 12. In another embodiment, the controller 72 may analyze the signals from the torque sensing device 70 and output hydraulic signals for actuating and/or releasing the brake assembly 60.

It should be noted that the controller 72 may be used in some embodiments for directly controlling the brake assembly 60. In other embodiments, the brake assembly 60 may be actuated via a mechanical assembly that is calibrated to automatically activate the brake assembly 60 when the torque on the tubular element 50 reaches a desired value (e.g., the predetermined torque value or the torque threshold). As such, the brake assembly 60 may not be controlled by any control components (e.g., the controller 72 and/or the torque sensing device 70), but rely instead on previously calibrated mechanical, pneumatic, and/or hydraulic actuating components to activate the brake assembly 60 at the target torque.

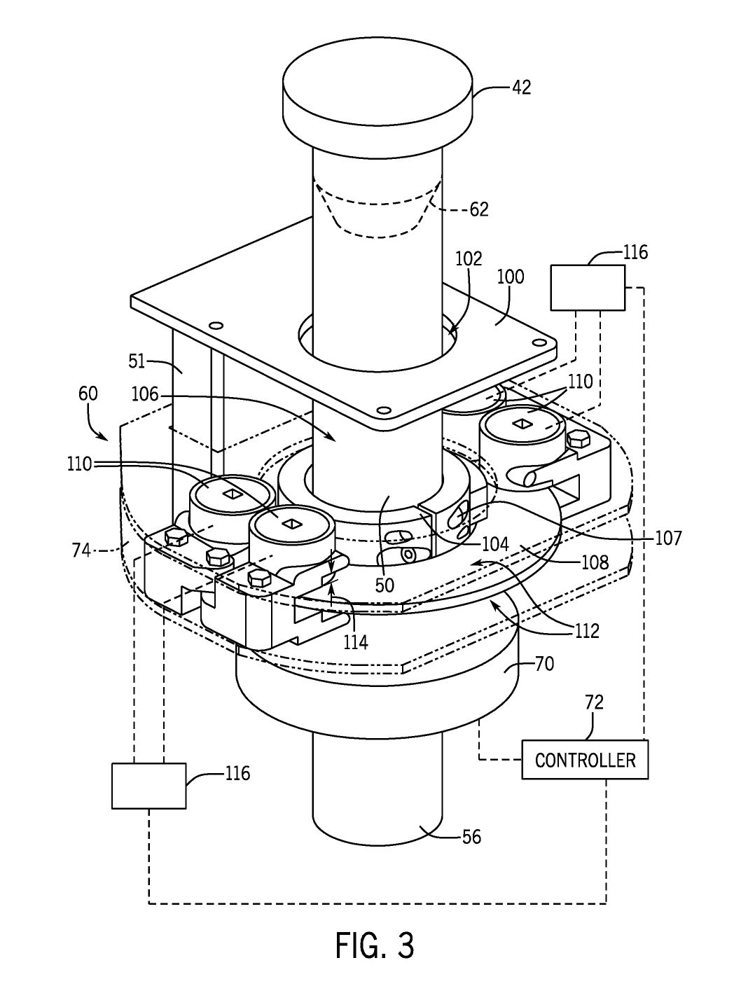

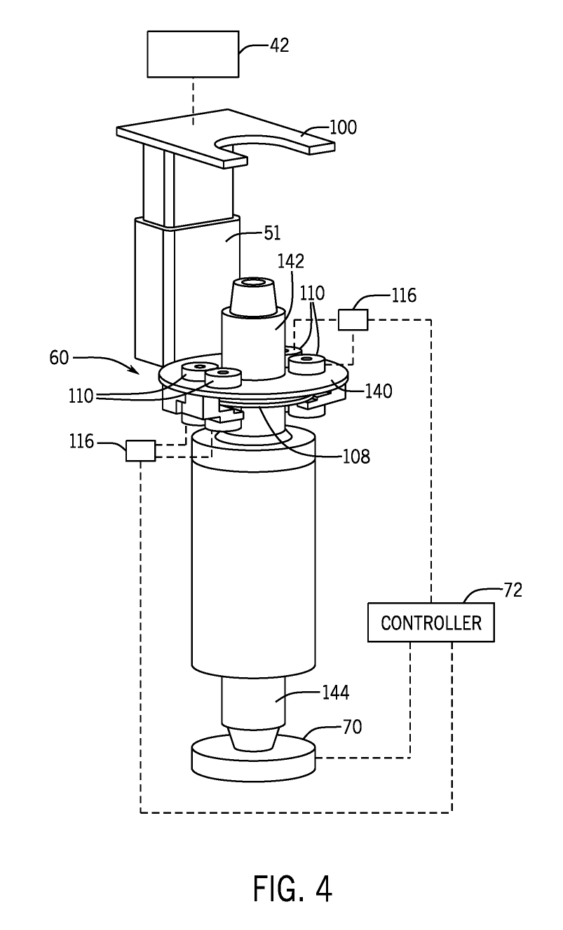

As shown in the illustrated embodiment of FIG. 2, the brake assembly 60 is disposed between the grabber box 51 and the torque sensing device 70 (e.g., wireless torque turn system (WTTS)). Additionally or alternatively, the brake assembly 60 may be coupled to the grabber box 51 and/or the torque track 20 (see, e.g., FIGS. 3 and 4). For example, the brake assembly 60 may include brake discs and/or brake drums disposed in a housing 74. The housing 74 may be coupled to the grabber box 51 via a clamp, a flange with a plurality of fasteners, a weld, and/or another suitable technique.

In the illustrated embodiment of FIG. 2, the drilling rig 10 also includes a casing drive system 76 positioned below the torque sensing device 70. The casing drive system 76 is configured to reciprocate and/or rotate the tubular string 56 (e.g., casing) during casing operations. In some embodiments, the casing drive system 76 is placed above the rig floor 12. However, in other embodiments the casing drive system 76 may be placed beneath the rig floor 12, at the rig floor 12, within the wellbore 52, or any other suitable location on the drilling rig 10 to enable rotation of the tubular string 56 during casing operations. In some embodiments, the controller 72 may control the operation of the casing drive system 76. For example, the controller 72 may increase or decrease the speed of rotation of the tubular string 56 based on wellbore conditions (e.g., received from feedback from sensors disposed in the wellbore 52).

Having now discussed the general components of the drilling rig 10 having the brake assembly 60 and the functions performed by these components, more detailed examples of the brake assembly 60 will be described with reference to FIGS. 3 and 4. For example, FIG. 3 is a perspective view of an embodiment of the brake assembly 60 introduced in FIGS. 1 and 2. As shown in the illustrated embodiment of FIG. 3, the brake assembly 60 includes the housing 74 coupled the grabber box 51 of the torque track 20. As shown the grabber box 51 includes an anti-rotation plate 100 that may include a bore 102 through which the tubular element 50 extends. In some embodiments, the anti-rotation plate 100 blocks movement of the tubular element 50 along the axis 48, such that a position of the tubular element 50 is substantially maintained with respect to the axis 54. In some embodiments, the top drive 42 is coupled to the tubular element 50 via the quill 62, for example. The brake assembly 60 is configured to extend around the tubular element 50. As discussed above, the brake assembly 60 may be coupled to (or integral with) other components of the drilling rig 10 and positioned in any suitable location to block torque transfer from the top drive 42 to the tubular element 50 at the predetermined torque value (e.g., the target torque).

For example, the brake assembly 60 includes a clamp 104 which may surround an outer circumference 106 of the tubular element 50. The clamp 104 may be tightened around the outer circumference 106 of the tubular element 50 via a die bolt 107. As such, the die bolt 107 secures the clamp 104 around the outer circumference 106 of the tubular element 50, such that the clamp 104 rotates when the top drive 42 drives rotation of the tubular element 50. Additionally, the clamp 104 is coupled to a disc 108 of the brake assembly 60. As shown in the illustrated embodiment of FIG. 3, the disc 108 may surround the clamp 104, and thus, rotate with the clamp 104 and the tubular element 50. In some embodiments, the disc 108 may be formed integrally with the clamp 104. In other embodiments, the disc 108 is coupled to the clamp 104 via a weld, a fastener, and/or another suitable technique. In any case, the brake assembly 60 includes a plurality of calipers 110 disposed partially above and partially below opposing surfaces 112 of the disc 108. The plurality of calipers 110 is actuated to cinch or clamp around the disc 108 when the torque applied to the tubular element 50 by the top drive 42 reaches the predetermined torque value or the torque threshold. While the illustrated embodiment of FIG. 3 shows the brake assembly 60 having four calipers 110, it should be recognized that in other embodiments, the brake assembly 60 includes less than four of the calipers 110 (e.g., three, two, or one calipers 110) or more than four of the calipers 110 (e.g., five, six, seven, eight, nine, ten or more of the calipers 110).

In some embodiments, each of the plurality of calipers 110 is spaced a distance 114 from the opposing surfaces 112 of the disc 108 when the top drive 42 operates below the predetermined torque value. When the top drive 42 applies an amount of torque to the tubular element 50 that reaches the predetermined torque value or the torque threshold, one or more actuators 116 (e.g., a hydraulic actuator, a pneumatic actuator, and/or an electronic actuator) may actuate one or more of the plurality of calipers 110, such that the plurality of calipers 110 move toward the disc 108 and ultimately reduce the distance 114 until the plurality of calipers 110 contact the opposing surfaces 112 of the disc 108. As the one or more calipers 110 contact the opposing surfaces 112 of the disc 108, friction is applied to the disc 108 via the calipers 110, which ultimately blocks rotation of the disc 108. Blocking rotation of the disc 108, in turn, blocks rotation of the clamp 104, and thus, blocks torque transfer from the top drive 42 to the tubular element 50. The torque applied to the tubular element 50 by the top drive 42 is thus maintained at the predetermined torque value. For example, the speed at which the plurality of calipers 110 is actuated may be relatively fast, and thus, the torque applied to the tubular element 50 by the top drive 42 upon blocking torque transfer from the top drive 42 by the plurality of calipers 110 is approximately equal to (e.g., within 10% of, within 5% of, or within 1% of) the predetermined torque value. As discussed above, in some embodiments, the plurality of calipers 110 may be actuated gradually when the torque applied to the tubular element 50 by the top drive 42 reaches the torque threshold. As such, the torque applied to the tubular element 50 by the top drive 42 may continue to increase up to the predetermined torque value while the plurality of calipers 110 are gradually actuated. When the torque reaches the predetermined torque value, the plurality of calipers 110 may be fully actuated, such that torque transfer from the top drive 42 to the tubular element 50 is substantially blocked at the predetermined torque value.

As shown in the illustrated embodiment of FIG. 3, the torque sensing device 70 is positioned below the brake assembly 60 with respect to the rig floor 12. In some embodiments, the torque sensing device 70 is a wireless torque turn system (WTTS) that provides wireless signals to the controller 72. The wireless signals include feedback indicative of a torque applied to the tubular element 50 by the top drive 42. Further, the controller 72 may be communicatively coupled to the brake assembly 60, such that the controller 72 activates the brake assembly 60 when the feedback from the torque sensing device 70 (e.g., the WTTS) reaches the predetermined torque value (e.g., a target torque) or the torque threshold. For example, the controller 72 may be coupled to the one or more actuators 116 (e.g., a hydraulic actuator, a pneumatic actuator, and/or an electronic actuator) that are configured to actuate the plurality of calipers 110 to block rotation of the disc 108, and thus, block torque transfer from the top drive 42 to the tubular element 50. While the illustrated embodiment of FIG. 3 shows the torque sensing device 70 positioned below the brake assembly 60 with respect to the rig floor 12, the torque sensing device 70 may be positioned in any suitable location of the drilling rig 10.

In the illustrated embodiment of FIG. 3, the brake assembly 60 includes the disc 108 and the plurality of calipers 110 that ultimately block torque transfer from the top drive 42 to the tubular element 50 at the predetermined torque value. Additionally or alternatively, the brake assembly 60 may include a drum brake system. For example, the brake assembly 60 includes a drum that is coupled to the clamp 104 and/or to the tubular element 50. The drum thus rotates with the tubular element 50 as the top drive 42 applies torque to the tubular element 50. When the torque applied to the tubular element 50 by the top drive 42 reaches the predetermined torque value or the torque threshold, one or more shoes of the brake assembly 60 may be actuated to expand radially outward (or radially inward) to contact the drum and block rotation of the drum. As such, torque transfer from the top drive 42 to the tubular element 50 is also blocked.

Further, once rotation of the disc 108 is blocked by the plurality of calipers 110, the torque at a connection point between the tubular element 50 and the tubular string 56 is approximately equal to (e.g., within 10% of, within 5% of, or within 1% of) the predetermined torque value (e.g., the target torque). When the brake assembly 60 is actuated, the controller 72 may send a signal to the top drive 42 to disrupt a supply of power to a motor of the top drive 42. Therefore, the top drive 42 no longer applies a torque to the tubular element 50. The controller 72 may then send another signal to the one or more actuators 116 of the plurality of calipers 110 to release the plurality of calipers 110. In other words, the plurality of calipers 110 no longer contact the opposing surfaces 112 of the disc 108. Therefore, any residual torque may be dissipated along the tubular element 50, while maintaining the torque at the connection point between the tubular element 50 and the tubular string 56 at the predetermined torque value. It should be recognized that the top drive 42 remains coupled to the tubular element 50 and may apply torque or remove torque from the tubular element 50 after the brake assembly 60 has been actuated. Further, the brake assembly 60 does not include rotating components similar to the clutch of existing systems, such that maintenance of the brake assembly 60 is reduced.

FIG. 4 is a perspective view of an embodiment of the brake assembly 60, in accordance with an aspect of the present disclosure. As shown in the illustrated embodiment of FIG. 4, the plurality of calipers 110 is disposed on a mounting disc 140 that is coupled to the grabber box 51. Further, the brake assembly 60 includes the disc 108, which is integral to a brake assembly quill 142. In some embodiments, the quill 62 of the top drive 42 couples to the quill 142 of the brake assembly 60. As such, the clamp 104 is not disposed around the tubular element 50. Instead, the tubular element is coupled to the brake assembly 60 via a sub 144. Therefore, the brake assembly 60 is positioned between the top drive 42 and the tubular element 50. In any case, the plurality of calipers 110 is actuated by the controller 72 when the torque sensing device 70 determines that the torque applied to the tubular element 50 reaches the predetermined torque value or the torque threshold. The plurality of calipers 110 thus blocks rotation of the disc 108, which blocks rotation of the quill 142 of the brake assembly 60 and/or the quill 62 of the top drive 42.

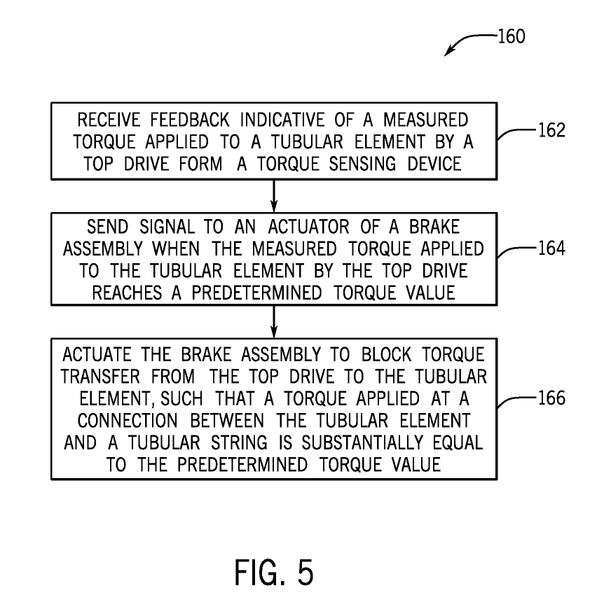

FIG. 5 is a process flow diagram illustrating a method 160 for operating the brake assembly 60 during drilling operations. For example, at block 162, the controller 72 receives feedback indicative of a torque applied to the tubular element 50 by the top drive 42 from the torque sensing device 70. As discussed above, the torque sensing device 70 may include the WTTS, which is configured to wirelessly transmit the signal to the controller 72. For example, the WTTS may send the signal using Wi-Fi, Bluetooth, and/or another suitable wireless transmission technique. In other embodiments, the torque sensing device 70 may be coupled to the controller 72 using a wired connection.

In any case, at block 164, the controller 72 sends a signal to the one or more actuators 116 of the brake assembly 60 (e.g., controlling operation of the plurality of calipers 110) when the torque applied to the tubular element 50 by the top drive 42 reaches the predetermined torque value or the target torque. In some embodiments, the actuation of the plurality of calipers 110 of the brake assembly 60 is relatively fast, such that the plurality of calipers 110 of the brake assembly 60 are actuated when the feedback from the torque sensing device 70 reaches the predetermined torque value. As such, torque transfer from the top drive 42 to the tubular element 50 is blocked when the torque at the connection point between the tubular element 50 and the tubular string 56 is substantially equal to (e.g., within 10% of, within 5%, or within 1% of) the predetermined torque value. In other embodiments, the plurality of calipers 110 may be gradually actuated when the feedback from the torque sensing device 70 reaches the torque threshold. For example, the torque applied to the tubular element 50 by the top drive 42 may continue to increase from the torque threshold to the predetermined torque value while the plurality of calipers 110 are gradually actuated. When the feedback from the torque sensing device 70 indicates that the torque applied to the tubular element 50 from the top drive 42 reaches the predetermined torque value, the plurality of calipers 110 may be fully actuated, such that torque transfer from the top drive 42 to the tubular element 50 is substantially blocked at the predetermined torque value. In any case, the brake assembly 60 may enable the connection between the tubular element 50 and the tubular string 56 to be formed at approximately (e.g., within 10% of, within 5% of, or within 1% of) the predetermined torque value.

Further, at block 166, the plurality of calipers 110 is actuated upon receipt of the signal from the controller 72. The plurality of calipers 110 contact the opposing surfaces 112 of the disc 108 to ultimately block rotation of the disc 108, the clamp 104, the tubular element 50, and/or the quill 62 of the top drive 42. Additionally or alternatively, a power supply to the motor of the top drive 42 may be disrupted, such that torque is no longer transferred to the tubular element 50 via the top drive 42. As such, the plurality of calipers 110 may be released to enable residual torque to dissipate along the tubular element 50, while maintaining a torque at the connection point between the tubular element 50 and the tubular string 56 at the predetermined torque value.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A drilling system, comprising:
a top drive of a drilling rig configured to transfer a torque to a tubular element;
a torque sensing component configured to measure the torque applied to the tubular;
a brake assembly coupled to the tubular element, wherein the brake assembly is configured to block torque transfer from the top drive to the tubular element at a predetermined torque value; and
a controller communicatively coupled to the torque sensing component and the brake assembly, wherein the controller is configured to receive feedback from the torque sensing component and send a signal to actuate the brake assembly based on the torque measured by the torque sensing component.

2. The drilling system of claim 1, wherein the brake assembly comprises:
a disc coupled to the tubular element and configured to rotate with the tubular element; and
a plurality of calipers configured to contact the disc when the torque measured by the torque sensing component reaches the predetermined torque value or a threshold torque to ultimately block rotation of the disc and the tubular element.

3. The drilling system of claim 2, wherein the disc is integrally formed with a first quill of the brake assembly.

4. The drilling system of claim 3, wherein the first quill of the brake assembly is configured to couple to the top drive.

5. The drilling system of claim 2, wherein the brake assembly comprises an actuator communicatively coupled to the controller, wherein the actuator is configured to actuate the plurality of calipers to move from a default position to contact the disc when the torque measured by the torque sensing component reaches the predetermined torque value or a threshold torque, wherein the threshold torque is less than the predetermined torque value.

6. The drilling system of claim 5, wherein the actuator is configured to gradually actuate the plurality of calipers to move from the default position to contact the disc when the torque measured by the torque sensing component reaches the threshold torque, such that the torque transfer from the top drive to the tubular element is ultimately blocked at the predetermined torque value.

7. The drilling system of claim 2, wherein the brake assembly comprises a clamp configured to be rotationally secured to the tubular element, such that the clamp rotates with the tubular element.

8. The drilling system of claim 7, wherein the clamp is secured to the tubular element via a die bolt.

9. The drilling system of claim 1, wherein the torque sensing component comprises a wireless torque turn system (WTTS).

10. A drilling system, comprising:
a torque sensing component configured to measure a torque provided from a top drive to a tubular element;
a brake assembly configured to couple to the tubular element, wherein the brake assembly is configured to block torque transfer from the top drive to the tubular element at a predetermined torque value; and
a controller communicatively coupled to the torque sensing component and the brake assembly, wherein the controller is configured to receive feedback from the torque sensing component and send a signal to actuate the brake assembly based on the torque measured by the torque sensing component.

11. The drilling system of claim 10, comprising the top drive, wherein the top drive is configured to transfer torque to the tubular element.

12. The drilling system of claim 10, wherein the brake assembly comprises:
a housing configured to couple to a torque track system coupled to the top drive;
a disc disposed within the housing, wherein the disc is configured to couple to the tubular element and configured to rotate with the tubular element; and
a plurality of calipers disposed in the housing, wherein the plurality of calipers is configured to contact the disc when the torque measured by the torque sensing component reaches the predetermined torque value or a torque threshold to block rotation of the disc and the tubular element.

13. The drilling system of claim 10, wherein the brake assembly comprises a clamp configured to secure to the tubular element, such that the clamp rotates with the tubular element.

14. The drilling system of claim 13, wherein the clamp is secured to the tubular element via a die bolt.

15. The drilling system of claim 10, wherein the torque sensing component is positioned below the brake assembly with respect to a drilling floor of the drilling system.

16. The drilling system of claim 10, wherein the torque sensing component is a wireless torque turn system (WTTS).

17. A method, comprising:
receiving feedback indicative of a measured torque value applied to a tubular element by a top drive from a torque sensing device;
sending a first signal to an actuator of a brake assembly based on the measured torque value applied to the tubular element by the top drive; and
actuating the brake assembly to block torque transfer from the top drive to the tubular element, such that a torque applied at a connection between the tubular element and a tubular string is substantially equal to a predetermined torque value.

18. The method of claim 17, comprising disrupting a supply of power to a motor of the top drive when the measured torque value applied to the tubular element by the top drive reaches the predetermined torque value.

19. The method of claim 18, comprising sending a second signal to the actuator of the brake assembly to release the brake assembly, such that the brake assembly does not block rotation of the tubular element.

20. The method of claim 17, wherein actuating the brake assembly to block rotation of the tubular element comprises actuating a plurality of calipers to contact a disc coupled to the tubular element.
